(19) United States
(12) Patent Application Publication
(10) Pub. No.: US 2010/0262547 A1
(43) Pub. Date: Oct. 14, 2010

(54) USER INFORMATION BROKERING

(75) Inventors: Eran Yariv, Zichron (IL); Roy Varshavsky, Tel Aviv (IL)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/423,026

(22) Filed: Apr. 14, 2009

(51) Int. Cl. G06Q 20/00; G06F 17/30; G06Q 40/00

(52) U.S. Cl. 705/80; 707/E17.108; 705/39

(57) ABSTRACT

User information corresponding to a plurality of users can be received at a user information collector computing environment and stored in a user information computer database. A general offer from a purchaser to purchase at least part of the user information can be received at a user information broker. Also at the broker, individual offers for the users can be processed. Each of the individual offers can be an offer to purchase access by the purchaser to user information corresponding to one of the users. Acceptances of the individual offers can be received by the broker from accepting users. A broker payment to the broker can be received from the purchaser, and a user payment can be sent to each of the accepting users. In addition, user information corresponding to the accepting users can be sent to the purchaser. User information data mining can also be done.

### BACKGROUND

More and more user information is digitally stored on computers. Much of that user information is accessible by the corresponding user in an online and secure fashion. Some examples include monetary records (e.g., bank account and credit card records), health records (e.g., hospitalization and insurance records), and social records (e.g., Facebook social network records). Such information is often stored on a computer that does not belong to the user and is controlled by a service provider (e.g., a bank, credit company, insurance company, or social network company). The service provider is often obligated to refrain from sharing the user information with third parties to protect the user's privacy for public relations reasons, and often for legal reasons (e.g., because of privacy regulations).

### SUMMARY

The techniques and tools described herein relate to user information brokering techniques that can provide valuable user information to purchasing third parties, as well as the payment of valuable benefits to users corresponding to that user information.

In one embodiment, the tools and techniques can include at a user information collector computing environment, receiving user information including information corresponding to a plurality of users. The user information can be stored in a user information computer database. One or more general offers from a purchaser to purchase at least a portion of the user information can be received at a user information broker. Also at the user information broker, individual offers for the plurality of users can be processed. Each of the individual offers can be an offer to purchase access by the purchaser to user information corresponding to a user of the plurality of users. One or more acceptances of one or more of the individual offers can be received from one or more accepting users at the user information broker. A user information broker payment to the user information broker can be received from the purchaser, and a user payment can be sent to each of the one or more accepting users. In addition, user information corresponding to the one or more accepting users can be sent to the purchaser from the user information computer database.

In another embodiment of the tools and techniques, user information can be received from a plurality of users, the user information including information corresponding to the users. The user information can be stored in a user information computer database. An inquiry from a purchaser regarding the user information can be received, and in response to the inquiry, the user information computer database can be queried. A response to the inquiry can be sent to the purchaser. In addition, one or more general offers from the purchaser to purchase at least a portion of the user information can be received.

In yet another embodiment of the tools and techniques, user information corresponding to a plurality of users can be received and stored in a user information computer database at a broker computing environment. In addition, one or more general offers from a purchaser to purchase at least a portion of the user information corresponding to the plurality of users can be received at the broker computing environment. Individual offers to purchase permission for user information corresponding to one or more users of one or more client computing environments to be shared with the purchaser can be sent from the broker computing environment to the one or more client computing environments. One or more acceptances of one or more of the individual offers from one or more accepting users of the one or more client computing environments can be received at the broker computing environment. A user information broker payment to a user information broker can be received from the purchaser. The broker can be a broker that controls the broker computing environment. In addition, a user payment can be sent to each of the one or more accepting users. Additionally, user information corresponding to the one or more accepting users can be sent from the user information computer database to the purchaser.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is schematic diagram of a user information brokering system and environment.

FIG. 3 is a schematic diagram of a user information brokering technique.

FIG. 4 is a schematic diagram of a data mining technique.

FIG. 5 is a flowchart of a user information brokering technique.

FIG. 6 is a flowchart of a data mining technique.

### DETAILED DESCRIPTION

Described embodiments are directed to techniques and tools for improved brokering of user information. Such improvements may result from the use of various techniques and tools separately or in combination.

As used herein, user information refers to information corresponding to a particular user or group of users. In many instances, a party other than the user would not share such information with others without obtaining the user's consent. Some such user information may include extremely sensitive information that a user would not want to share with third parties under any circumstances (e.g., bank records). However, other types of user information is not as sensitive (e.g., social network data), and many users would be inclined to share such information with specific third parties if the users were provided with the right incentive. The tools and techniques discussed herein provide a system for providing and coordinating the brokerage of user information to third parties who might be interested in that information and are willing to pay for it.

Accordingly, one or more substantial benefits can be realized from the user information brokering tools and techniques described herein. For example, the tools and techniques can provide valuable user information to purchasing third parties, as well as the payment of valuable benefits to users corresponding to that user information.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

### I. Exemplary Computing Environment

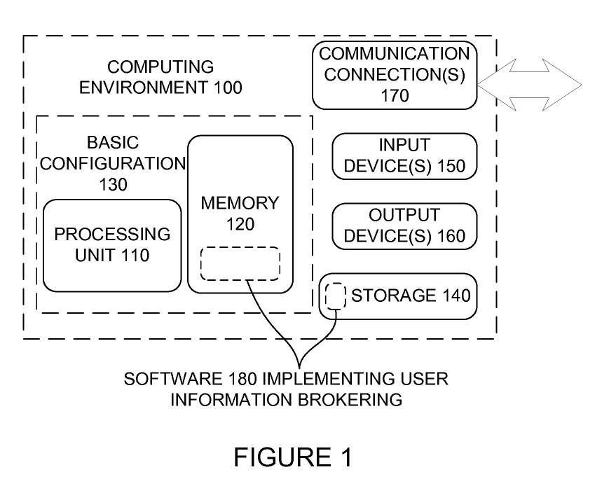

FIG. 1 illustrates a generalized example of a suitable computing environment (100) in which one or more of the described embodiments may be implemented. For example, one or more such computing environments can be used as a user information broker computing environment, client computing environment, or purchaser computing environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing user information brokering.

Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “send,” and “receive” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. User Information Brokering System and Environment

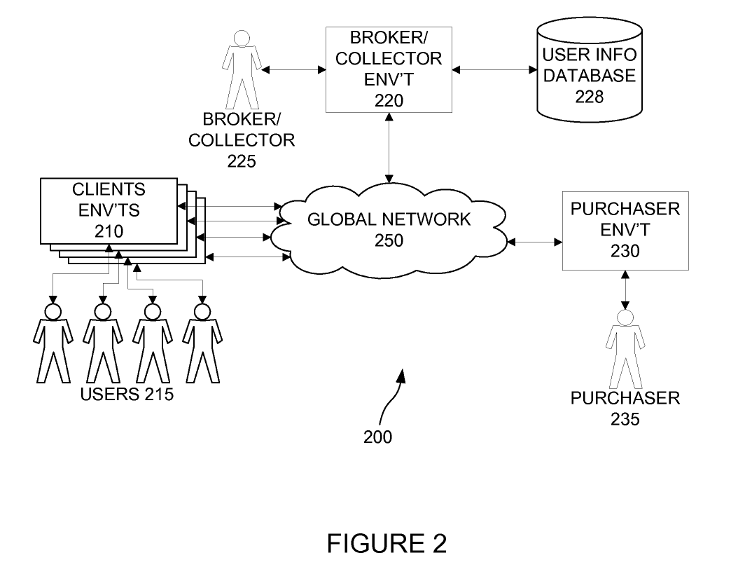

FIG. 2 is a block diagram of a user information brokering system (200) in conjunction with which one or more of the described embodiments may be implemented. The user information brokering system (200) can include one or more client computing environments (210), which can receive input from corresponding user(s) (215). The user information brokering system (200) can also include a broker/collector computing environment (220), which can receive input from a broker/collector (225). The broker/collector environment (220) can also store user information in a user information database (228). The user information brokering system (200) can also include a purchaser computing environment (230), which can receive user input from a purchaser (235).

The users (215), the broker/collector (225), and the purchaser (235) can each be an individual, or a group of individuals working together. For example, a user (215), broker/collector (225), or purchaser (235) can include one or more cooperating organizations or entities (e.g., business entities). The users (215) are the parties whose personal user information is collected and brokered. The broker/collector (225) acts as a collector to collect the users' information and store it in the database (228). The database (228) can be any data structure that represents the users' information, including but not limited to a SQL database structure. The database (228) may be stored on a single machine or multiple machines. The broker/collector (225) can also act as a broker to broker the purchase of the users' information by the purchaser (235). Alternatively, one party may act as an information collector, and another party may act as an information broker. Additionally, there may be one user information collector computing environment and a different user information broker computing environment, rather than a single broker/collector environment (220).

Each of the computing environments (210, 220, and 230) can include multiple computing devices, systems, networks, etc., so long as the environment is configured to interact with the same user (215), broker/collector (225), or purchaser (235), respectively. For example, a single client computing environment (210) can include a handheld computing device and a desktop computing device, so long as both computing devices are configured to interact with the same user (215).

In some situations, the users (215), broker/collector (225), and the purchaser (235) may interact with each other via the corresponding computing environments (210, 220, and 230). The computing environments (210, 220, and 230) can be connected to communicate with each other via one or more wired or wireless computer networks. For example, the computing environments (210, 220, and 230) can all be connected to a global computer network (250), such as the Internet. Such communications can take various forms, such as HTTP or HTTPS messages. Data may be sent between the computing environments (210, 220, and 230) in other ways, such as using portable storage devices. The users (215), broker/collector (225), and the purchaser (235) may also interact with each other in other ways that do not directly involve the corresponding computing environments (210, 220, and 230), such as by direct communication between individuals or by sending payments or other messages by courier or regular mail.

### III. User Information Brokering & Mining Techniques Illustrating Communications

A. User Information Brokering Technique Described with Reference to Examples

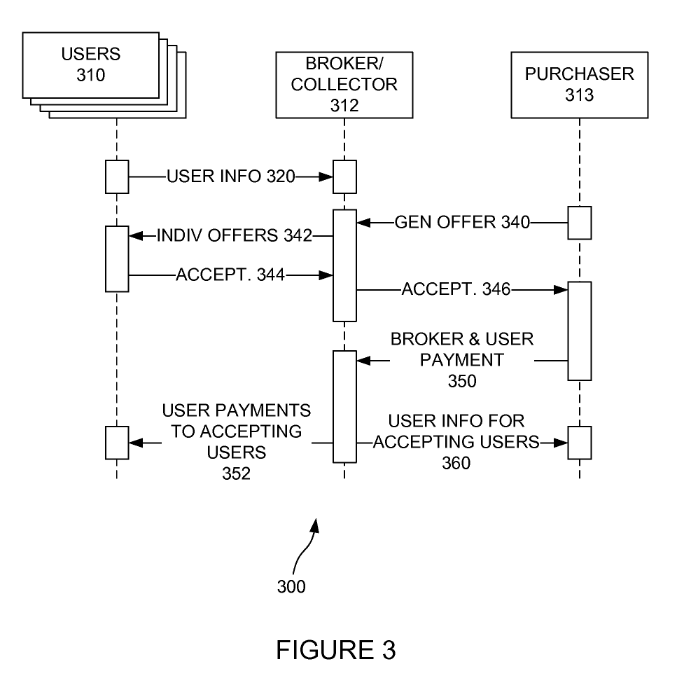

Referring now to FIG. 3, a user information brokering technique (300) will be described. The user information brokering technique (300) can include communications between one or more users (310), a broker/collector (312), and a purchaser (313).

Users (310) can send user information (320) to the broker/collector (312). In a first example, each user (310) can carry a GPS-enabled device, such as a GPS-enabled smart phone, which can periodically send location data over a wireless network to the broker/collector (312), which can be a wireless service provider. In a second example, each user (310) can provide blood or tissue samples to the broker/collector (312), which can analyze the samples to produce DNA analysis data. In this DNA example, the users (310) may also provide additional data (e.g., physical traits, physical ailments, etc.) to the broker/collector (312). In a third example, each user can send digital visual images to the broker/collector (312) over a global computer network so that the images can be shared with others as part of an on-line photo album.

The purchaser (313) can send to the broker/collector (312) a general offer (340) to purchase user information. The general offer (340) may take multiple different forms, such as a single message or multiple messages corresponding to particular users or groups of users. In the first example discussed above, the purchaser (313) can be a regional transit authority who wishes to perform an analysis of users' movements through the region in order to improve transit services. In that example, the general offer (340) can specify that the transit authority is willing to pay $10 plus free bus and train passes for one person for one year in return for location data for the past year for each user who traveled from a suburb into a particular downtown area and back during at least half of the business days during that year. In the second example discussed above, the purchaser (313) can be a university that is conducting genetic research, and the general offer (340) can specify that the university is willing to pay $100 per user for specified DNA information for users meeting a specified DNA profile. In the third example discussed above, the purchaser (313) can be an insurance company that is investigating the robbery of a bank covered by one of its policies, and the general offer (340) can specify that the insurance company is willing to pay $50 for each photograph taken in the vicinity of the bank building on a particular day when the robbery occurred.

In response to receiving the general offer (340), the broker/collector (312) can process individual offers (342) for each of the users (310) whose information meets the criteria of the general offer (340), such as by generating and sending the individual offers (342) to the users (310). The individual offers (342) can include offers of benefits (with broker payments to be made to the broker/collector (312) already omitted). Individual offers can identify the purchaser (313), although such identification may be omitted in some situations. For example, a purchaser (313) may wish to offer more money, but withhold its identity from the users (310). The individual offers (342) may also include other information, such as statements of how the purchaser (313) will use the information, and a deadline for accepting the offers (342). In the first example discussed above, the individual offers (342) can specify that the transit authority is willing to pay free bus and train passes for one person for one year in return for the user's location data for the past year, which leaves $10 per person for the broker payment. In the second example discussed above, the individual offers (342) can specify that the university is willing to pay $80 per user for specified DNA information, which leaves $20 per person for the broker payment. In the third example discussed above, the individual offers (342) can specify that the insurance company is willing to pay $40 for each photograph taken in the vicinity of the bank building on a particular day when the robbery occurred, which leaves $10 per accepting user for the broker payment.

Referring still to FIG. 3, a subset of the users (310) (which may be one, some, or all of the users to whom the individual offers (342) were sent) can send user acceptances (344) to the broker/collector (312). In response to receiving the user acceptances (344), the broker/collector (312) can send broker acceptances (346) to the purchaser (313). The broker acceptances (346) can inform the purchaser (313) of how many users (310) accepted. The broker acceptances (346) can take many different forms, such as a single message for each acceptance as it is received, or a single message for all acceptances, which can be sent after a an acceptance deadline has passed. These acceptances (344 and 346) can be sent in the same manner for each of the three examples discussed above, or they could be done differently for different examples.

In response to receiving the acceptances (346) from the broker/collector (312), the purchaser (313) can send a broker and user payment (350) to the broker/collector (312). In some implementations, the purchaser (313) may send the user payments directly to the users (310), but in other implementations identifying information of the users (310) is withheld from the purchaser (313) as much as possible, so that the purchaser (313) often cannot make such payments directly to the users (310). The payments discussed herein can be made in various different ways. For example, money payments can be sent by providing a check or cash in person, by courier or by mail; by wire transfer; or by utilizing a payment processing service such as PayPal. The broker and user payment (350) can be made in one bulk payment, in one payment per accepting user, or in some other manner. In the first example discussed above, sending the broker and user payment (350) can include sending money in addition to actual bus and train passes, or sending money in addition to access codes that would allow accepting users (310) to obtain the free bus and train passes. In the second example discussed above, sending the broker and user payment (350) can include sending $100 per accepting user to the broker/collector (312). In the third example discussed above, sending the broker and user payment (350) can include sending $50 per accepting user to the broker/collector (312).

In response to receiving the broker and user payment (350), the broker/collector (312) can send user payments (352) to the accepting users (310). These payments (352) can be sent in any of various ways, such as the ways of sending payments discussed above with reference to the broker and user payment (350). In the first example discussed above, the user payments (352) can be sent by sending bus and train passes to the accepting users (310) by courier or regular mail, or by sending access codes to the accepting users (310) by digital transmission (e.g., by email or by notifying users to log onto a secure website to obtain the codes). The broker/collector (312) can retain the broker payment ($10 in the first and third examples, and $20 in the second example).

In response to receiving the broker and user payment (350), the broker/collector (312) can also send the user information (360) for the accepting users (310) to the purchaser (313). This can be done in the same manner for each of the three examples discussed above, although different information will be sent in each example (location data, DNA data, and digital images, respectively). For example, this can be done by making the information available via a secure web interface, by sending the information (360) via mail or courier on a portable storage device, by sending an email, etc.

Many different alternative user information brokering techniques could be used. For example, different bidding or offering techniques could be used. As just a few examples, users could be allowed to accept individual offers by making a counter-offer, which would be considered an acceptance if the counter-offer were accepted by the purchaser. As another example, the purchaser could offer different payments for user information that is different in kind, quality, or amount. In one specific example of this, the purchaser in example two discussed above could pay more money to have the user actually come to the purchaser's facility to participate in a study. Indeed, a purchaser could initially offer a lower amount for some amount of information, and then offer a higher amount for additional information for some of the accepting users that are of particular interest to the purchaser.

As yet another alternative, some of the messages described above may be re-ordered or omitted altogether. For example, a purchaser may be particularly trustworthy, or may have made a large monetary deposit with the broker/collector prior to making a general offer. In that situation, the broker/collector may immediately send corresponding user information to the purchaser when an acceptance is received from an accepting user, rather than forwarding a broker acceptance and waiting for a response from the purchaser. As another alternative example, a user may indicate that the user will accept any offers equal to or greater than a minimum amount for particular user information. If the broker/collector receives a general offer above the minimum amount for that information, the broker/collector can process the general offer and send an acceptance to the purchaser without sending an offer to the user. This is because the user has already sent an acceptance to the offer, in the form of a blanket acceptance for all such offers.

B. Data Mining Technique

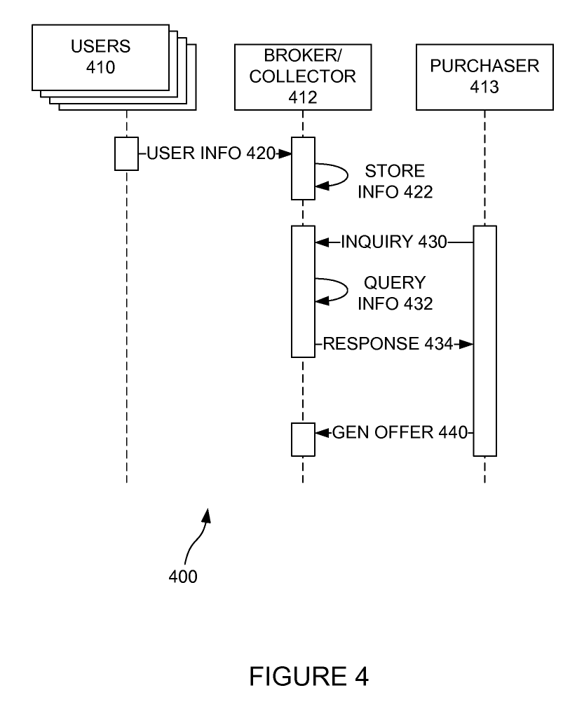

Referring now to FIG. 4, a data mining technique (400) will be described with reference to communications between, and actions performed by, one or more users (410), a broker/collector (412), and a purchaser (413). As used herein, mining data refers to the technique of purchasers submitting inquiries regarding stored user information and being provided with responses to those inquiries, where the responses are based on the user information. Mining can include the purchasers submitting many such inquiries, or only a single inquiry.

In the technique (400), the users (410) can provide user information (420) to the broker/collector (412). The broker/collector (412) can receive the user information (420) and store (422) the information, such as in a user information database in a broker/collector computing environment.

The purchaser (413) can send an inquiry (430) to the broker/collector (412) regarding the user information. The purchaser (413) can be provided with a data mining tool to facilitate the mining of data. For example, the data mining tool may be a web interface, where the purchaser can interact with the web interface over a global computer network, and the interface can interact with a backend user information database, such as a SQL database. Upon receiving the inquiry (430), the broker/collector (412) can query (432) the user information, such as by querying (432) a user information database in the broker/collector computing environment.

The broker/collector (412) can send a response (434) to the inquiry (430), providing the purchaser (413) with the requested information. The response (434) may include only general information (e.g., indications of how many users fit one or more criteria specified in the inquiry (430)), or include very little information related to particular users so that the users' privacy will be maintained and the purchaser will still be motivated to purchase further information. For example, in data mining related to digital images, the response may only include tags associated with the digital images, only one image from an entire album, or only low resolution (e.g., “thumbnail”) images. In data mining related to DNA information, the response may only include the number of user records that meet particular criteria. As one example, the response may include reviews and ratings from purchasers who had previously purchased that same user information.

Based on one or more responses (434), the purchaser can decide to submit a general offer (440) to purchase user information. A user information brokering technique can continue from there, such as in the manner discussed above with reference to FIG. 3.

As a specific example of data mining, a transit authority may submit an inquiry, which asks how many users have location information showing that the users travel along a particular freeway an average of at least four times per day. The response could indicate a number of user records in the user database fitting those criteria. If an insufficient number of records were available fitting those criteria, then the purchaser could submit a second inquiry, asking how many users have location information showing that the users travel along the particular freeway an average of at least two times per day. If a sufficient number of such records are available, then the transit authority can make a general offer to purchase the user information for the users fitting the criteria of the second inquiry.

### IV. User Information Brokering & Mining Techniques Illustrated by Flowcharts

A. User Information Brokering Technique

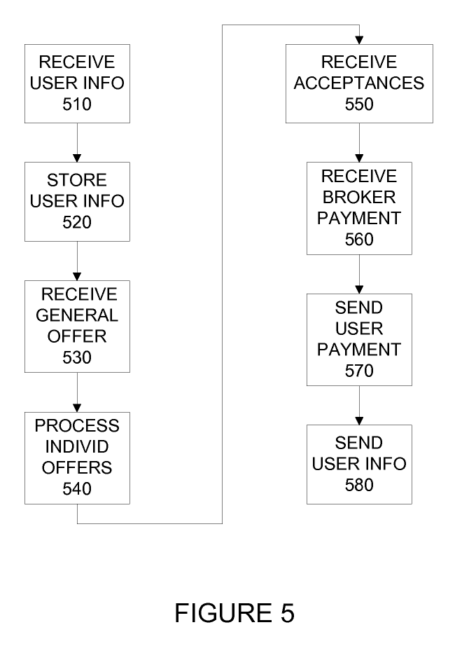

Referring to FIG. 5, a user information brokering technique will be described. In the technique, user information can be received (510), such as user information being received by a broker/collector at a broker/collector computing environment from one or more users at one or more client computing environments. The user information can be stored (520), such as being stored in a user information database in the broker/collector computing environment.

A general offer to purchase at least some of the user information (i.e., purchase access to the information) can be received (530). For example, the offer can be received (530) by the broker/collector at the broker/collector computing environment from a purchaser at a purchaser computing environment.

In response to receiving the general offer, one or more individual offers can be processed (540). For example, the individual offers can be generated and sent by the broker/collector from the broker/collector computing environment to one or more corresponding users at one or more client computing environments.

Acceptances of the individual offers can be received (550), such as by being received by the broker/collector at the broker/collector computing environment from one or more users at one or more client computing environments.

In addition, a broker payment can be received (560). For example, the broker payment can be received by the broker/collector at the broker/collector computing environment. The broker/collector computing environment can include computing systems of one or more banks or other financial institutions in which the broker/collector has one or more accounts.

A user payment can be sent (570). For example, the user payment can be sent (570) from the broker/collector at the broker/collector computing environment to one or more accepting users at corresponding client computing environments. As with the broker/collector computing environments, the client computing environment can include computing systems of one or more banks or other financial institutions in which the corresponding clients have accounts.

In addition, the user information can be sent (580). For example, the user information can be sent (580) by the broker/collector at the broker/collector computing environment to the purchaser at the purchaser computing environment.

B. Data Mining Technique

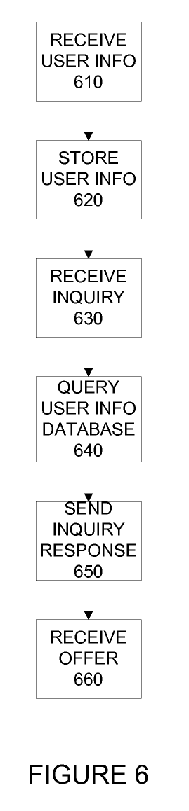

Referring now to FIG. 6, a data mining technique will be described. In the technique, user information can be received (610), such as user information being received by a broker/collector at a broker/collector computing environment from one or more users at one or more client computing environments. The user information can be stored (620), such as being stored at a user information database in the broker/collector computing environment.

An inquiry regarding the stored user information can be received (630). For example, the inquiry can be received (630) by the broker/collector at the broker/collector computing environment. In response to the inquiry being received (630), the user information database can be queried (640) to obtain information requested in the inquiry. For example, the query could be conducted by broker/collector computer environment. A response can be sent (650). The response can include information requested in the request. For example, the response can be sent by the broker/collector from the broker/collector computing environment to the purchaser at the purchaser computing environment.

A general offer to purchase at least some of the user information (i.e., purchase access to the information) can be received (660). For example, the offer can be received (660) by the broker/collector at the broker/collector computing environment from the purchaser at the purchaser computing environment. A user information brokering technique can continue from there, such as in the manner discussed above with reference to FIG. 5.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A method comprising:
at a user information collector computing environment, receiving user information comprising information corresponding to a plurality of users;
storing the user information in a user information computer database;
receiving at a user information broker one or more general offers from a purchaser to purchase at least a portion of the user information;
at the user information broker, processing individual offers for the plurality of users, each of the individual offers being an offer to purchase access by the purchaser to user information corresponding to a user of the plurality of users;
receiving at the user information broker one or more acceptances of one or more of the individual offers from one or more accepting users;
receiving a user information broker payment to the user information broker from the purchaser;
sending a user payment to each of the one or more accepting users; and
sending to the purchaser user information corresponding to the one or more accepting users from the user information computer database.

2. The method of claim 1, wherein the user information computer database is controlled by the user information broker.

3. The method of claim 1, wherein processing the individual offers comprises sending the individual offers to the plurality of users.

4. The method of claim 3, wherein:
receiving one or more general offers comprises receiving one or more general offers at a user information broker computing environment from a purchaser computer environment; and
sending the individual offers to the plurality of users comprises sending the individual offers from the user information broker computing environment to one or more client computing environments.

5. The method of claim 4, wherein:
the user information collector computing environment and the user information broker computing environment are the same computing environment; and
receiving the one or more acceptances comprises receiving the one or more acceptances at the user information broker computing environment from one or more client computing environments corresponding to the one or more accepting users.

6. The method of claim 4, wherein receiving the one or more acceptances comprises receiving the one or more acceptances at the user information broker computing environment.

7. The method of claim 1, further comprising:
receiving an inquiry from the purchaser regarding the user information;
querying the user information computer database in response to receiving the inquiry; and
sending the purchaser a response to the inquiry.

8. The method of claim 7, wherein receiving the inquiry and sending the response are done using a data mining tool provided to the purchaser.

9. The method of claim 8, wherein the data mining tool comprises a web interface.

10. The method of claim 7, wherein sending the purchaser the response to the inquiry is done prior to receiving the one or more general offers from the purchaser.

11. The method of claim 7, wherein the response comprises an indication of how many users fit one or more criteria specified in the inquiry.

12. The method of claim 1, wherein the user payment comprises a payment of money.

13. A computer system comprising:
means for receiving user information from a plurality of users, the user information comprising information corresponding to the users;
means for storing the user information in a user information computer database;
means for receiving an inquiry from a purchaser regarding the user information;
means for querying the user information computer database in response to receiving the inquiry;
means for sending the purchaser a response to the inquiry; and
means for receiving one or more general offers from the purchaser to purchase at least a portion of the user information.

14. The computer system of claim 13, wherein the means for receiving the inquiry and the means for sending the response to the inquiry comprise a data mining tool.

15. The computer system of claim 14, wherein the data mining tool comprises a web interface that is configured to interact with the computer database.

16. The computer system of claim 13, wherein the response comprises an indication of how many users fit one or more criteria specified in the inquiry.

17. The computer system of claim 13, further comprising:
means for sending one or more individual offers to a subset of the plurality of users, the individual offers comprising, for each user of the subset, an individual offer for the purchaser to purchase user information corresponding to that user; and
means for receiving one or more acceptances of one or more of the individual offers from one or more accepting users of the subset.

18. The computer system of claim 17, further comprising:
means for receiving a user information broker payment from the purchaser;
means for sending a user payment to each of the one or more accepting users; and
means for sending to the purchaser computing environment user information corresponding to the one or more accepting users from the user information computer database.

19. One or more computer-readable media having computer-executable instructions embodied thereon that, when executed, perform acts comprising:
at a broker computing environment, receiving user information corresponding to a plurality of users;
storing the user information in a user information computer database at the broker computing environment;
receiving at the broker computing environment one or more general offers from a purchaser to purchase at least a portion of the user information corresponding to the plurality of users;
sending from the broker computing environment to one or more client computing environments individual offers to purchase permission for user information corresponding to one or more users of the one or more client computing environments to be shared with the purchaser;
receiving at the broker computing environment one or more acceptances of one or more of the individual offers from one or more accepting users of the one or more client computing environments;
receiving a user information broker payment to a user information broker from the purchaser, the user information broker controlling the user information broker computing environment;
sending a user payment to each of the one or more accepting users; and
sending user information corresponding to the one or more accepting users from the user information computer database to the purchaser.

20. The one or more computer-readable media of claim 19, wherein sending the user payment to each of the one or more accepting users comprises sending payment information to a payment processing system.
